(19) United States
(12) Patent Application Publication
(10) Pub. No.: US 2011/0175463 A1
(43) Pub. Date: Jul. 21, 2011

(54) RECIPROCATING MAGNET ENGINE

(75) Inventor: John W. Ketchersid, JR., Smyrna, GA (US)

(73) Assignee: Energy Engines, Inc., Cumming, GA (US)

(21) Appl. No.: 13/010,073

(22) Filed: Jan. 20, 2011

Related U.S. Application Data
(60) Provisional application No. 61/296,855, filed on Jan. 20, 2010.

(51) Int. Cl. H02K 35/00

(52) U.S. Cl. 310/15

(57) ABSTRACT

A reciprocating magnet engine has first and second magnet pairs (20A and 40A, 20B and 40B), first and second sections (15, 35), a continuous flux return plate (15G) and a core (15C) which have high relative magnetic permeabilities, an interrupting flux return plate (25) which has a high relative magnetic permeability but has a low relative magnetic permeability section (26) therein, a control shaft (27), an output drive shaft (50), and first and second drive assemblies (45). A small torque on the control shaft provides a large torque on the output drive shaft.

### PRIORITY CLAIM

This patent application claims the priority of provisional patent application 61/296,855 filed Jan. 20, 2010, entitled “Reciprocating Permanent Magnet Engine”, by John W. Ketchersid, Jr.

### FIELD OF THE INVENTION

The present invention relates to magnetic engines or motors.

### BACKGROUND OF THE INVENTION

Conventional magnetic engines or motors have a rotor, often called an armature, and a stator, often being either a magnet or a field winding. The rotor and the stator each typically have two or more poles. The poles of the rotor may be either permanent magnets or electromagnets. The poles of the armature are typically created by a set of electromagnets mounted radially on a driveshaft. These engines rely upon the magnetic attraction and/or repulsion between the poles of the rotor and stator to rotate the rotor, and thus to turn the drive shaft to produce output power or torque.

### BRIEF SUMMARY OF THE INVENTION

Disclosed is a reciprocating magnet engine has first and second magnet pairs, first and second sections, a continuous flux return plate and a core which have high relative magnetic permeabilities, an interrupting flux return plate which has a high relative magnetic permeability but has a low relative magnetic permeability section therein, a control shaft, an output drive shaft, and first and second drive assemblies.

Each magnet pair has a primary magnet and a corresponding opposing magnet aligned upon a common axis, the primary magnet and the opposing magnet each have a magnetic field and are oriented so that their magnetic fields are in opposition.

The first section has first and second voids and the primary magnets of the first and second magnet pairs are secured in the first and second voids, respectively. The first section has a continuous flux return plate and a core to conduct the magnetic fields of the primary magnets.

The second section has third and fourth voids extending through it. The opposing magnets of the first and second magnet pairs are movable in a linear motion within the third and fourth voids, respectively. The second section conducts the magnetic fields of the opposing magnets.

An interrupting flux return plate is interposed between the first section and the second section. The interrupting flux return plate is composed of a high relative magnetic permeability material and also has a low relative magnetic permeability section therein. The interrupting flux return plate has a closed position with respect to a magnet pair where the high relative magnetic permeability section is between the primary and opposing magnets of the magnet pair and substantially reduces magnetic interaction between the primary and opposing magnets in that magnet pair, and the opposing magnet is attracted to the high relative magnetic permeability section which is between the primary and opposing magnets of that magnet pair. The interrupting flux return plate also has an open position with respect to a magnet pair where the low relative magnetic permeability section is between the primary and opposing magnets of the magnet pair. The low relative magnetic permeability section is sized to allow substantial magnetic interaction between the primary and opposing magnets in the magnet pair when the interrupting flux return plate is in the open position with respect to the magnet pair.

The first section and the interrupting flux return plate complete a magnetic flux path for a primary magnet of a magnet pair when the interrupting flux return plate is in the closed position with respect to the magnet pair. The second section and the interrupting flux return plate complete a magnetic flux path for an opposing magnet of a magnet pair when the interrupting flux return plate is in the closed position with respect to the magnet pair.

The control shaft is connected to the interrupting flux return plate, the core, and the continuous flux return plate and rotates these components.

The first and second drive assemblies connect the opposing magnets to an output drive shaft in a complementary manner to allow the opposing magnets to move in a reciprocating relationship with respect to the output drive shaft and to rotate the output drive shaft.

Also disclosed is a magnetic field controller has a continuous flux return plate, a core connected to the continuous flux return plate, an interrupting flux return plate connected to the core, and a control shaft to rotate the continuous flux return plate, the core, and the interrupting flux return plate. The control shaft is connected to at least one of the continuous flux return plate, the core, or the interrupting flux return plate. The continuous flux return plate, the core, and the interrupting flux return plate are composed of high relative magnetic permeability materials, but the interrupting flux return plate also has a low relative magnetic permeability section. If a magnet is between the continuous flux return plate and the interrupting flux return plate then the magnetic field, as seen outside the interrupting flux return plate, can be turned on and off by rotating the interrupting flux return plate so that the low relative magnetic permeability section is over, or is not over, respectively, the magnet. Similarly, if a device is between the continuous flux return plate and the interrupting flux return plate and a magnet is outside the flux return plate, then the magnetic field, as seen by the device, can be turned on and off by rotating the interrupting flux return plate so that the low relative magnetic permeability section is over, or is not over, respectively, the device. Preferably, but not necessarily, the magnetic field controller also has an enclosure to enclosure the continuous flux return plate and the core, and to enclose the side of the interrupting flux return plate connected to the core.

### BRIEF DESCRIPTION OF THE SEVERAL VIEWS OF THE DRAWING

FIG. 1 is an exploded side view of an exemplary embodiment of the present invention.

FIG. 2 is a top view of an exemplary central section illustrating an exemplary central flux return plate.

FIG. 3 is a top view of an exemplary bottom section body illustrating the primary magnets and core therein.

FIG. 4 is a top view of an exemplary bottom plate and bottom flux return plate.

FIG. 5 is a top view of an exemplary upper section body illustrating the opposing magnets therein.

FIG. 6 is a top view of an exemplary top flux return plate.

FIG. 7 is an illustration of an alternative embodiment.

FIGS. 8A and 8B are top view and side views, respectively, of an illustration of an exemplary magnet mount or piston cup.

### DETAILED DESCRIPTION OF THE INVENTION

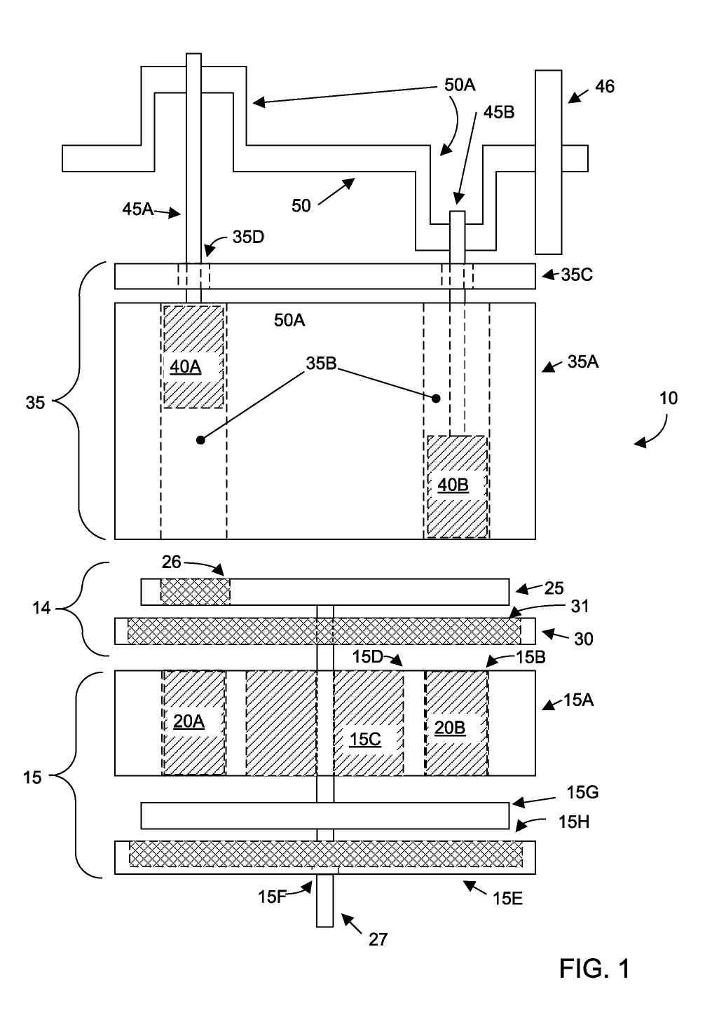

FIG. 1 is an exploded side view of an exemplary embodiment 10 of the present invention and shows a lower section 15, a central section 14, an upper section 35, an output drive shaft 50, and an optional flywheel 46.

The lower section 15 has two magnets 20A, 20B, a cylindrical central core 15C, a body 15A with voids or holes 15B, 15D therein to accommodate the primary magnets and the central core, a circular bottom flux return plate or disk 15G, a bottom plate 15E having a void or space 15H therein to enclose the plate 15G, and a control shaft 27 which is connected to the disks 15G and 25 and the central core 15C, and a hole 15F to accommodate the shaft 27. The two primary magnets 20A, 20B are secured within the voids 15B in body 15A, such as by use of a high-strength glue, press-fitting, or other desired technique, such that the magnets 20 are restrained from moving. The core 15C turns freely within the void 15D of body 15A, and the bottom flux return plate 15G turns freely within the void 15H of bottom plate 15E. The bottom flux return plate 15G may also sometimes be referred to herein as a continuous flux return plate.

The central housing 14 has a circular central flux return plate or disk 25 with at least one specialized section 26 therein, and a central spacer 30 having a void 31 therein to enclose the plate 25 which turns freely therein. The control shaft 27, the disks 15G and 25, and the central core 15C are connected together and turn as a unit. The central flux return plate 25 may also sometimes be referred to herein as an interrupting flux return plate.

The upper magnet housing 35 has a body 35A with two cylinders 35B therein, two magnets 40A, 40B which reciprocate within the cylinders, drive assemblies 45A, 45B connected to the magnets 40A, 40B, and a top flux return plate 35C with two holes 35D therein to accommodate the drive assemblies. The magnets 40A, 40B are connected by drive assemblies 45A, 45B, respectively, to the output drive shaft 50. Preferably, but optionally, a flywheel 46 is mounted to the drive shaft 50 to smooth the speed of rotation of the shaft 50.

The magnets 20A, 20B are sometimes referred to herein as primary magnets or fixed magnets, and the magnets 40A, 40B are sometimes referred to herein as opposing magnets or moving magnets.

The central flux return plate 25, the bottom flux return plate 15G, the core 15C, and the top flux return plate 35C each have a high relative magnetic permeability (relative to the magnetic permeability of air or a vacuum). A high relative magnetic permeability is preferably 2000 or higher. This is a preference, and is not a limitation. The specialized section 26 of plate 25 has a low relative magnetic permeability (for example, approximately 1), and may be, for example, a plastic material or even a void area or hole in the plate 25. In a preferred embodiment, the section 26 is a hole and, therefore, the specialized section 26 is sometimes referred to herein as a hole.

Consider now the operation of the engine. The primary magnets 20 have magnetic fields which are opposite to the magnetic fields of their opposing magnets 40. For example, the north pole of primary magnet 20A faces the north pole of opposing magnet 40A, and the south pole of primary magnet 20B faces the south pole of opposing magnet 40B. When the flux return plate 25 is in the position shown in FIG. 1 it will be noticed that the hole 26 is between magnets 20A and 40A so these magnets will forcefully repulse each other. In the preferred embodiment, magnet 20A is fixed in place so magnet 40A will move away from magnet 20A. In addition, the magnet 40A will be attracted to the top flux return plate 35C. Further, the high relative magnetic permeability section of plate 25 is under magnet 40B so magnet 40B is forcefully attracted to the plate 25 and therefore moves toward the plate 25.

When the high relative magnetic permeability material of plate 25 is between two magnets, such as between magnets 20B and 40B, this material redirects the lines of magnetic flux from these two magnets. In the case of magnet 20B, the lines of flux are redirected by the plate 25 and then return to the magnet 20B via the core 15C and bottom plate 15G. In the case of magnet 40B, the lines of flux are redirected by the plate 25 and the top plate 35C but, in contrast to the case of magnet 20B, the magnetic flux circuit is not completed by a high relative magnetic permeability material. Thus, the lines of flux from magnets 20B and 40B are generally shielded from each other by plate 25 and do not interact with each other.

The position of plate 25 wherein the high relative magnetic permeability section is between primary and opposing magnets of a magnet pair is sometimes referred to herein as the “closed” position with respect to those magnets, and the position of plate 25 wherein the low relative magnetic permeability section 26 is between the magnets of a magnet pair is sometimes referred to herein as the “open” position with respect to those magnets.

Now consider when control shaft 27 rotates plate 25 so that a hole 26 is now between magnets 20B and 40B. These magnets are suddenly “visible” to each other, and they are very close to each other, and their magnetic fields are in opposition. Therefore, there will be a large repulsive force which will push magnet 40B away from magnet 20B and toward the top of cylinder 35B. Also, the high relative magnetic permeability material of plate 25 will now be between magnets 20A and 40A so their magnetic fields will be largely shielded from each other and the repulsive force will not be present and magnet 40A will also be attracted to the plate 25.

Now consider when control shaft 27 further rotates plate 25 so that a hole 26 is again between magnets 20A and 40A. These magnets are suddenly “visible” to each other again, and they are very close to each other, and their magnetic fields are in opposition. Therefore, there will be a large repulsive force which will push magnet 40A away from magnet 20A and toward the top of cylinder 35A. Also, the high relative magnetic permeability material of plate 25 will again be between magnets 20B and 40B so their magnetic fields will be largely shielded from each other, the repulsive force will not be present, and magnet 40B will be attracted to the plate 25.

Thus, the rotation of the plate 25 has alternately caused the opposing magnet of a magnet pair to be attracted to the plate 25 and then to be forcefully repulsed away from the plate 25 and toward the top of cylinder.

The opposing magnets 40A and 40B are connected by drive assemblies 45A, 45B to the lobes 50A of an output drive shaft 50 in a crankshaft configuration so that linear motion (up and down within a cylinder) of the magnets 40A and 40B is converted into rotational motion of the drive shaft 50. Thus, rotational motion of the control shaft 27 is converted into rotational motion of the output drive shaft but, due to the strength of the magnets 20, 40, the torque has been amplified.

Note that the magnetic fields of magnets 40A and 40B are connected in series via the top flux return plate 35C and the interrupting flux return plate 25, but that there are substantial air gaps in this magnetic circuit, including the section 26. Similarly, the magnetic fields of magnets 20A and 20B are connected in series via the interrupting flux return plate 25 and the bottom flux return plate 15G. There are air gaps but, excluding section 26, they are small compared to the air gaps in the magnetic circuit path of magnets 40A and 40B. In addition, each of the magnets 20 also has a magnetic circuit path through the plate 15G, the core 15C, and the plate 25. Note that the magnetic field in core 15C is an alternating magnetic field. The magnetic field of magnet 20A dominates when the section 26 is over magnet 20B, and the magnetic field of magnet 20B dominates when the section 26 is over magnet 20A.

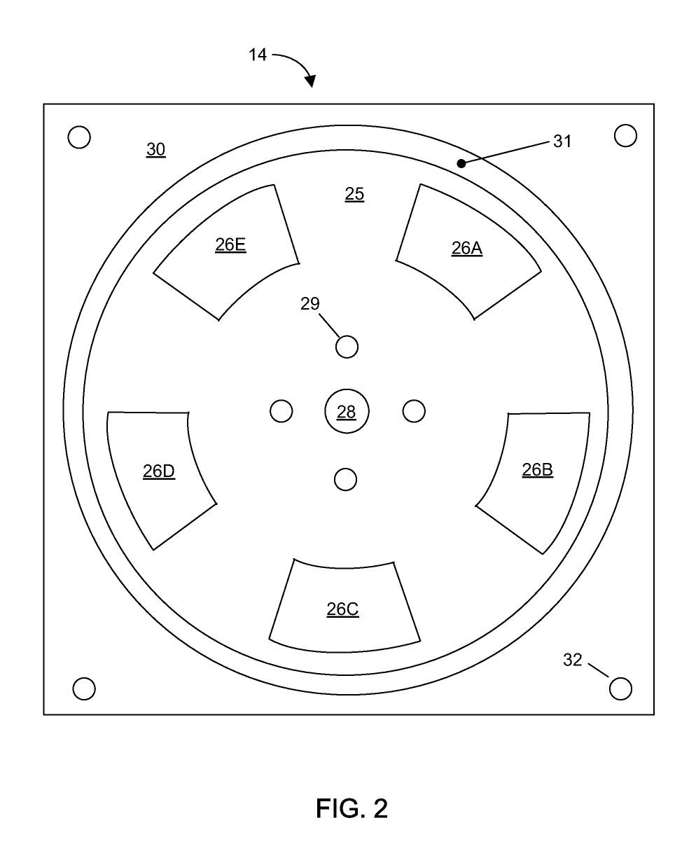

FIG. 2 is a top view of an exemplary central section 14 illustrating an exemplary central flux return plate 25, spacer 30, and the air gap formed between plate 25 and spacer 30 from hole 31. The size of the air gap has been exaggerated for ease of illustration but is preferably just large enough to allow plate 25 to turn freely within spacer 30. Preferably, but not necessarily, plate 25 has five low relative magnetic permeability sections 26A-26E. As few as one section 26 may be used, but an engine with only one section 26 may tend to vibrate excessively. More sections 26 may also be used, but if there are too many sections for the size of the plate then it may be difficult or impossible to achieve a fully open or fully closed position, thereby reducing the efficiency of the engine. An odd number of sections 26 is preferred because an even number of sections 26 may result in the plate 25 being in the open position for both magnet pairs simultaneously. The shape of a section 26 is not critical but is preferably of a shape and size to achieve a fully open position.

Also shown in FIG. 2 are an exemplary hole 28 for the control shaft 27 and exemplary mounting holes in plate 25 to secure the plate 25 to the core 15C and the control shaft 27. This is not critical and other techniques may be used to secure the plate to the core and the control shaft. In addition, FIG. 2 shows exemplary mounting holes 32 to accommodate bolts (not shown) to secure central section 14 to upper and lower sections 35 and 15.

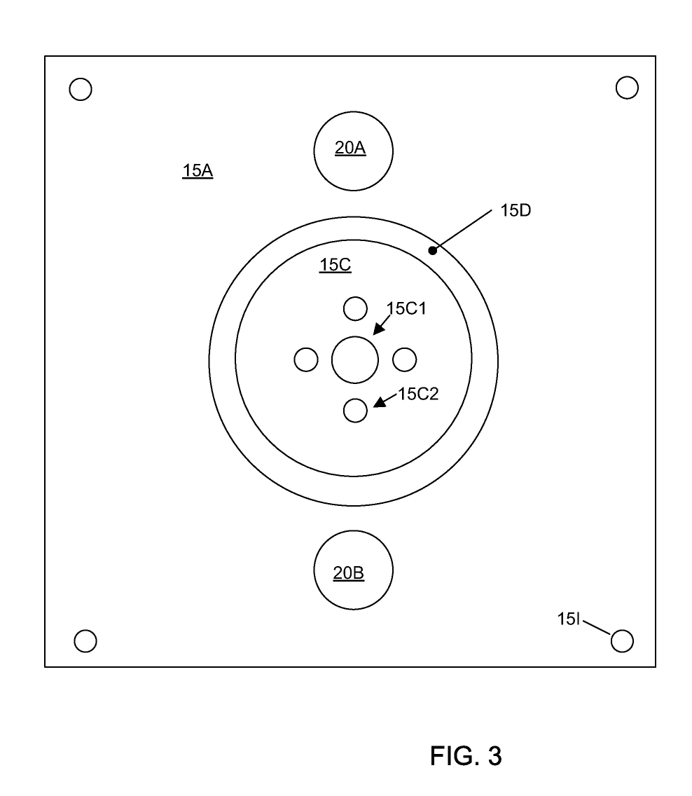

FIG. 3 is a top view of an exemplary bottom section body 15A illustrating the primary magnets 20A, 20B and core 15C therein. Also shown in core 15C are an exemplary hole 15C1 for the control shaft 27 and exemplary mounting holes 15C2 to secure the core to the plate 25 and the control shaft 27. Also shown are exemplary mounting holes 151 to accommodate bolts (not shown) to secure body 15A to bottom plate 15E and upper and lower sections 35 and 15. The size of air gap formed between core 15C and body 15A from hole 15D has been exaggerated for ease of illustration but is preferably just large enough to allow core 15C to turn freely within body 15A.

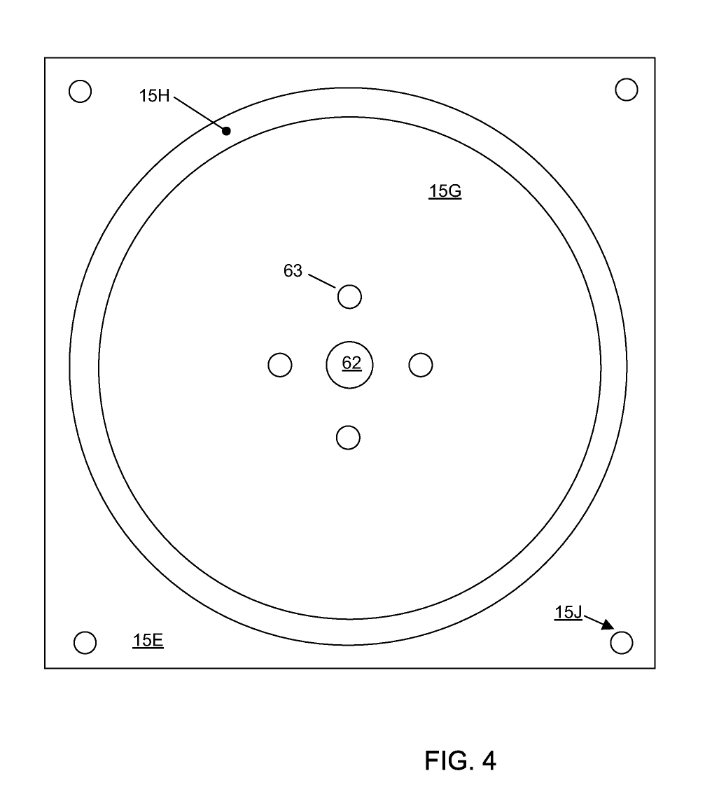

FIG. 4 is a top view of an exemplary bottom plate 15E and flux return plate 15G, and the air gap formed between plate 15G and body 15E from hole 15H. The size of the air gap has been exaggerated for ease of illustration but is preferably just large enough to allow plate 15G to turn freely within bottom plate 15E. A washer (not shown) is preferably used between plate 15G and body 15E to reduce friction between these components. Also shown in plate 15G are an exemplary hole 62 for the control shaft 27 and exemplary mounting holes 61 to secure the plate 25 to the core 15C and the control shaft 27. Also shown are exemplary mounting holes 15J to accommodate bolts (not shown) to secure bottom plate 15E to body 15A, spacer 30, and upper section 35.

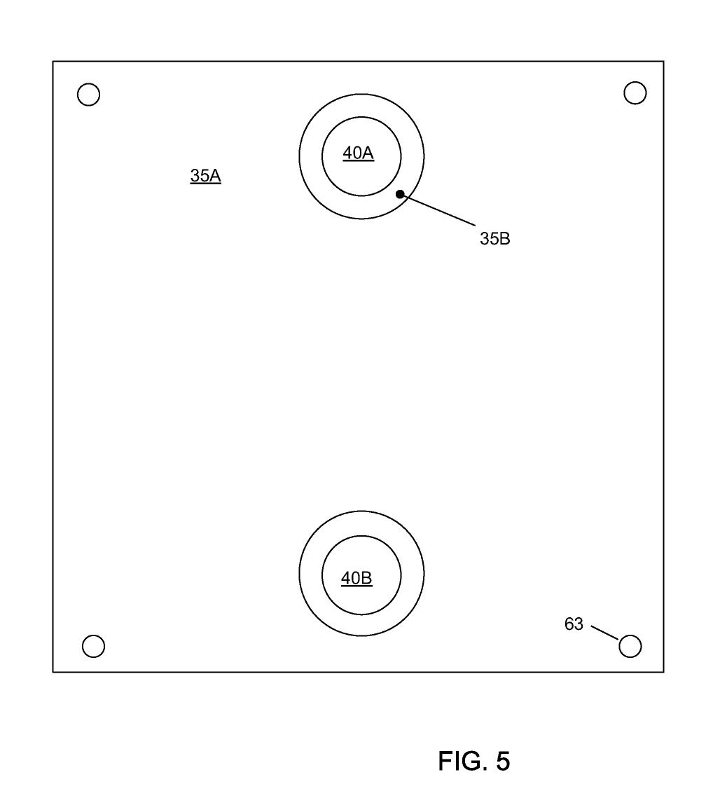

FIG. 5 is a top view of an exemplary upper section body 35 illustrating the opposing magnets 40A, 40B therein and the air gap formed between the magnets and body 35A from hole or cylinder 35B. The size of the air gap has been exaggerated for ease of illustration but is preferably just large enough to allow a magnet 40A, 40B to move up and down within its cylinder 35B.

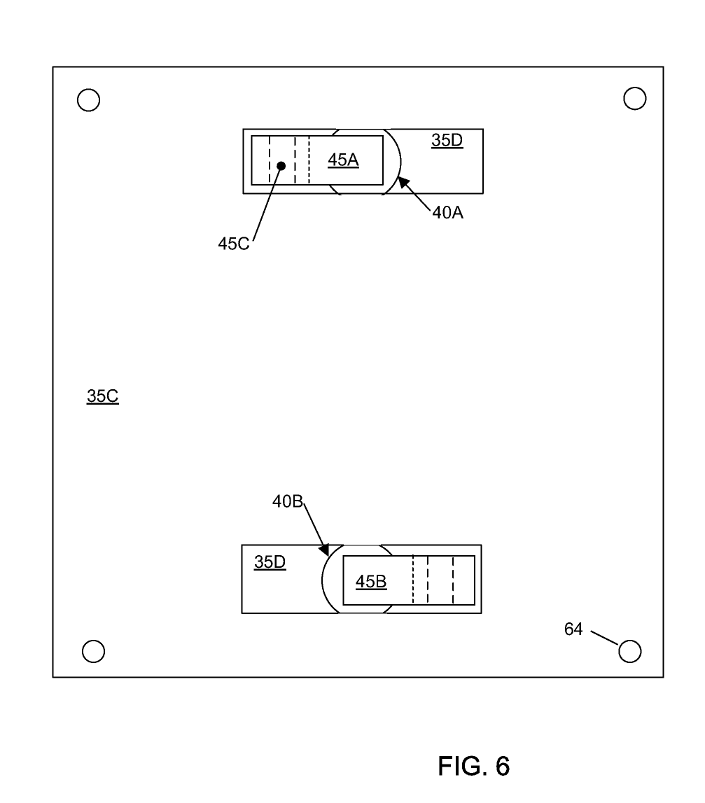

FIG. 6 is a top view of an exemplary top flux return plate 35C showing magnets 40A, 40B, holes 35D in the plate to accommodate the drive assemblies 45A, 45B, holes or channels 45C in the drive assemblies to accommodate the drive shaft 50 (not shown), and mounting holes 64 to accommodate bolts (not shown) to secure top plate 35C to the upper body 35A, the spacer 30, and the bottom section 15. The size of holes 35D is not critical but should be large enough to allow for the size and expected movement of drive assemblies 45.

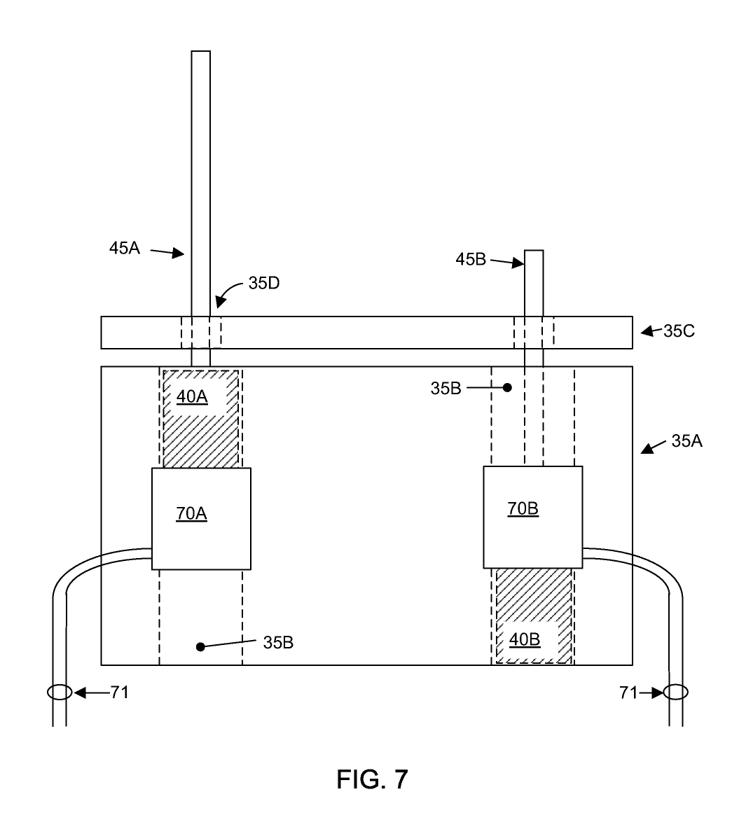

FIG. 7 is an illustration of an alternative embodiment. Coils 70A and 70B surround cylinders 35B. The output of a coil 70 appears on a conductor pair 71. As previously mentioned, magnets 40 have strong magnetic fields. Therefore, as they move up and down in cylinders 35 the lines of flux of magnets 40 cut through the coils 70 and generate electricity. The position of the coils 70 is not critical but midway along the length of a cylinder is preferred. Likewise, the number of turns and the construction of the coils 70 is not critical but will depend upon the output voltage and current desired.

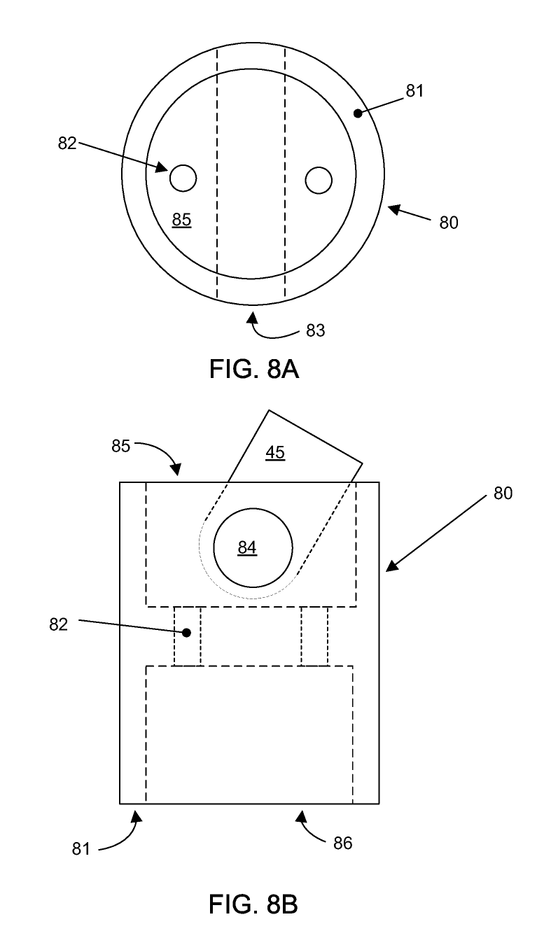

FIGS. 8A and 8B are top view and side views, respectively, of an illustration of an exemplary magnet mount or piston cup 80. Although it is possible to connect a magnet 40 directly to a drive assembly 45 the preferred manner of connection is to use a piston cup 80 to hold the magnets 40, and to connect the piston cup 80 to the drive assembly 45 by means of a wrist pin 84. This preserves the structural integrity of the magnet 40. The piston cup 80 has a wall 81, which may be a different thickness at the top (drive assembly end) than at the bottom (magnet end). There are two cavities in the piston cup formed by the wall 81. One cavity 85 is to accommodate a drive assembly 45; the other cavity 86 is to house a magnet 40 (not shown). There is a hole 83 through the top end of piston cup 80 for a wrist pin 84. The drive assembly is free to rotate, within limits, about the wrist pin. The wrist pin 84 may be press fit into the hole 83 in piston cup 80, or may be held within the hole 80 by other means if desired. The wrist pin thus rotationally secures the drive assembly 45 to the piston cup 80. The magnet 40 is joined to the piston cup 80 by two bolts (not shown) which are fed through holes 82. Thus, the magnet 40 and piston cup 80 function as a unit.

Although the exploded view may imply that there is a gap between the continuous flux return plate 15G, the core 15C, and the interrupting flux return plate 25 that is not the case. For best performance these components should be tightly held together so as to minimize the air gap and constrain the magnetic field as much as possible.

It should also be noted that a part of the embodiment described above is a magnetic field controller which can selectively interrupt a magnetic field with little input force. The magnetic field controller has a continuous flux return plate 15G, a core 15C connected to the continuous flux return plate, an interrupting flux return plate 25 connected to the core, and a control shaft 27 to rotate the continuous flux return plate, the core, and the interrupting flux return plate. The control shaft is connected to at least one of the continuous flux return plate, the core, or the interrupting flux return plate. The continuous flux return plate, the core, and the interrupting flux return plate are composed of a high relative magnetic permeability material, but the interrupting flux return plate also has a low relative magnetic permeability section. If a magnet 20 is between the continuous flux return plate and the interrupting flux return plate then the magnetic field, as seen outside the interrupting flux return plate, can be turned on and off by rotating the interrupting flux return plate so that the low relative magnetic permeability section is over, or is not over, respectively, the magnet. Similarly, if a device is between the continuous flux return plate and the interrupting flux return plate and a magnet 40 is outside the flux return plate, then the magnetic field, as seen by the device, can be turned on and off by rotating the interrupting flux return plate so that the low relative magnetic permeability section is over, or is not over, respectively, the device. Preferably, but not necessarily, the magnetic field controller also has an enclosure 30, 15A, 15E to enclosure the continuous flux return plate and the core, and to enclose the side of the interrupting flux return plate connected to the core.

The following paragraphs describe particulars regarding the fabrication of the components such as number of layers, material, etc., of a preferred embodiment. It should be noted that other materials and characteristics can also be used.

The lower section body 15A and the upper section body 35A are constructed from polycarbonate.

The interrupting flux return plate 25 should have sufficiently high relative permeability to attract an opposing magnet and to shield a primary magnet from its opposing magnet. In one embodiment, the interrupting flux return plate 25 comprises seven laminated layers, electrically insulated from each other. The layers are as follows, from top to bottom: (1) 1/16 inch (approximately 1.6 mm) of high iron content mild steel; (2) epoxy and paper insulator; (3) 1/16 inch low iron content tool steel; (4) epoxy and paper insulator; (5) 1/16 inch low iron content tool steel; (6) epoxy and paper insulator; and (7) 1/16 inch of high iron content mild steel.

The core 15C should have sufficiently high relative permeability to redirect and confine the magnetic flux from the magnets 20A, 20B. In one embodiment, the core 15C comprises five laminated layers. The layers need not be electrically insulated from each other. The layers are as follows, from top to bottom: (1) ½ inch (approximately 12.7 mm) thick high iron content mild steel; (2) ½ inch thick high iron content mild steel; (3) 1/16 inch (approximately 1.6 mm) thick high iron content mild steel; (4) ½ inch thick high iron content mild steel; and (5) ½ inch thick high iron content mild steel. Consider now the field dynamics that occur within the core 15C as the plate 15 rotates and moves between open and closed positions. The core has a high iron content, is being acted upon by inverse polarity magnetic fields (one from magnet 20A, the other from magnet 20B) that fluctuate rapidly (due to the rotation of the windows 26). The core acts similar to a capacitor in storing energy, but differs in that the magnetic moment, field strength, proximity and period of exposure determine the charge rate. Similarly, the discharge rate is also determined by these factors. In the preferred embodiment, the core is fully saturated by the field of the magnet 20 that is in the closed state (the plate 25 is in the closed position) and then discharges with a rapid field compression when that window opens. The core thus represents a large, high permeability, relatively low magnetic moment circuit for the fields presented by the magnets 20 and establishes a low resistance magnetic short circuit (which also has the benefit of guarding the magnets 20 against demagnetization) that effectively captures the field of a magnet 20. This brings the repelling force potential of a magnet 20 to near zero in relationship to its like polarity neighbor 40 when the plate 25 is in the closed position. As a result, the piston magnet 40 is attracted to the top flux return plate because the field of the magnet 20 has been diverted.

The bottom flux return plate 15G should also have sufficiently high relative permeability to redirect and confine the magnetic flux from the magnets 20A, 20B. In one embodiment the bottom flux return plate 15G comprises seven laminated layers. The layers are as follows, from top to bottom: (1) 1/16 inch (approximately 1.6 mm) low iron content tool steel; (2) epoxy and paper insulator; (3) 1/16 inch low iron content tool steel; (4) epoxy and paper insulator; (5) 1/16 inch low iron content tool steel; (6) epoxy and paper insulator; and (7) 1/16 inch low iron content tool steel. The layers of the bottom flux return plate 15G are thus made of a stainless steel that will conduct a magnetic field yet not allow the magnetic domains therein to establish themselves well enough to result in attraction. This, along with the interrupting flux return plate and the core, provides a full magnetic circuit but with a decrease in magnetic adhesion between the magnets and the plate 25. This further decreases the required initiator force required to operation the engine.

Preferably, both the interrupting and bottom flux return plates possess a plurality of holes, which are actually slots, having consistent distance between each slot. Each slot is an arch presenting an opening (window) of 40 degrees. Each metal plate section between two slots is thus approximately 32 degrees. This results in a total of five, 72-degree operational pairs on each plate 15G, 25, each 180 degrees off from the other. Thus, when an opening is presented to magnet pair 20A, 40A then a corresponding metal interface is beginning to enter the field of magnet pair 20B, 40B. This results in a moment of attraction of the plate 25 towards magnet pair 20B, 40B, thereby decreasing the required input torque to sever the relationship between the plate and magnet pair 20A, 40A. The force provided by this attraction also applies force to the synchronization assembly (not shown) and thereby decreases the required force to drive control shaft 27.

The top flux return plate 35C should also have sufficiently high relative permeability to redirect the magnetic flux from the magnets 40A, 40B. In one embodiment the top flux return plate 35C comprises seven laminated layers, electrically insulated from each other. The layers are as follows, from top to bottom: (1) 1/16 inch (approximately 1.6 mm) of high iron content mild steel; (2) epoxy and paper insulator; (3) 1/16 inch low iron content tool steel; (4) epoxy and paper insulator; (5) 1/16 inch low iron content tool steel; (6) epoxy and paper insulator; and (7) 1/16 inch of high iron content mild steel.

This number of layers in the top, interrupting and bottom flux return plates, and in the core, is not critical and more or fewer layers can be used; more layers may reduce the heating due to eddy currents but increases the cost of manufacture. More layers may also adversely affect the structural integrity of the plates or core if the same thickness is to be maintained.

Each time a hole (flux return window) in the interrupting flux return plate 25 closes on one of the magnet pairs the piston (opposing) magnet above the closing window is attracted to the high iron content of the topmost interrupting flux return plate lamination layer. This results in downward force on the down stroke of the piston. As the magnet moves down in the stroke, the force increases because the distance between the piston magnet and the interrupting flux return plate decreases. In a preferred embodiment, the piston magnet is no further than one inch (25.4 mm) from the top of the interrupting flux return plate at any time during its stroke when using a 2 inch diameter by 2 inch thick N52 NdBFe magnets (referred to herein simply as N52 magnets).

Each time a hole (flux return window) in the interrupting flux return plate 25 opens the piston magnet above the opening window initiates a set of induction fields within the flux return plate 25. In a preferred embodiment, the piston magnet is approximately 0.006 inch (approximately 0.16 mm) from the top of the interrupting flux return plate at any time during its stroke. This proximity of the piston magnet in relationship to the interrupting top flux return plate, a high velocity along the stroke of the piston magnet, and the axial rotation of the flux return plate results in acceleration of the plate along its axis of rotation and, thus, applies force to the synchronization assembly, which also transfers energy to the flywheel. If N52 magnets are used in a magnet pair then, at the center of the opening window, there is a repelling force of 216 pounds when the distance between the magnets is 0.028 inches (approximately 0.7 mm).

Use of more highly magnetically-permeable materials for the interrupting flux return plate materials, while maintaining the necessary structural integrity, will result in a thinner plate 25 and thereby allow closer proximity of the magnets in the magnet pair, which can increase the repelling force. Note that both magnets in a magnet pair will apply a strong pulling force to the plate 25 so the plate 25 must have sufficient rigidity not to deform so much that the plate 25 scrapes against the upper body section 35A, the lower body section 15A, or the magnets 20. 40.

The bolts (not shown) which pass through the three laminated components 25, 15C, 15G are electrically insulated from the flux return plates 25, 15G in a conventional manner. This may be done, for example, by using nylon bushings (not shown) surrounding the length of the bolt and fibrous insulation washers (not shown) at each end of the bolt (between the top layer and the bolt head, and between the bottom layer and the nut. Insulating the bolts from the layers is desirable in order to decrease electron state linkage within the top and bottom flux return plates and thereby decrease the X-Axis Lenz effect.

The drive assemblies 45 are preferably aluminum.

Also, as preferred, the north pole of one primary magnet, such as magnet 20A, faces in the opposite direction of the north pole of the other primary magnet, such as magnet 20B. The same is true for the opposing magnets. The opposite arrangement may also be used, i.e., the poles of the primary magnets face in the same direction, and the poles of the opposing magnets face in the same direction, but this is not preferred as operation of the engine is less efficient.

Also, as preferred, there are two magnet pairs and the interrupting flux return plate has 5 holes in it. Other configurations may also be used, such as more magnet pairs and/or more holes 26, but the number of magnet pairs should be even if the number of holes is odd, and vice versa. Also, the drive assemblies may become more complex or prone to wear if more magnet pairs are used.

Also, the bottom flux return plate 15G may have one or more holes, like plate 25. Preferably, the holes in plate 15G are 180 degrees out of phase with plate 25. If, for example, plate 25 is in the open position with respect to magnets 20A and 40A then a repulsive field will be present. Then, as plate 25 turns to the closed position the magnet 40A will be attracted to the plate 25. At the same time, plate 25 will begin shielding the flux from magnet 20A. In addition, plate 15G will be turning toward the open position with respect to the bottom of magnet 20A, thereby decreasing the magnetic field intensity due to the air gap introduced by the hole 26. This combination allows the magnet 40A to be more quickly attracted to the plate 25. Then, as the plate 25 continues turning, plate 15G will be turning toward the closed position with respect to the bottom of magnet 20A, while plate 25 will be turning toward the open position with respect to the magnet pair. This combination quickly reestablishes the magnetic field intensity of magnet 20A and magnet 40A is more quickly repulsed from the plate 25.

In addition, as mentioned, the magnet pairs work in a complementary manner so that when one magnet pair is pushing on a lobe 50A of the drive shaft 50 the other magnet pair is pulling on its corresponding lobe 50A of drive shaft 50. Thus, unlike a conventional piston engine wherein pistons only push on their corresponding lobes of a crankshaft, in the magnetic engine described herein magnet pairs both push and pull on their corresponding lobes 50A.

As mentioned, the speed or rotation of the interrupting flux return plate 25 tends to increase, particularly when under light or no load. This is due to the interaction of the magnetic fields of the magnets 20 and 40 with the rotating, high-permeability plate 25. This can result in power being undesirably fed back to a mechanism or motor (not shown) which is driving the control shaft 25. Thus, in an alternative embodiment, a one-way drive (not shown) is connected to the control shaft 27 and the mechanism (not shown) for driving the shaft 27. The one-way drive allows the mechanism to drive the control shaft 27, but slips when the control shaft 27 is attempting to drive the mechanism. Note that, in the configuration shown (5 holes 26, two magnet pairs), each rotation of the drive shaft 27 will cause 5 rotations of the drive shaft 50. If the load on drive shaft 50 is too heavy this synchronization may be lost and efficiency will suffer. Thus, in still another embodiment, a synchronizer (not shown) is added between the drive shaft 50 and the control shaft 27 so that the rotation of these two shafts is synchronized. Also, in a variation of this embodiment, the synchronizer is mounted between the top flux return plate 35C and the drive shaft 50, so the control shaft 27 may extend through body 35A so that it exits through the top flux return plate 35C for easy connection to the synchronizer.

The synchronizer allows the rotation or timing relationship between the drive shaft 50 (and the piston magnets 40) and the interrupting flux return plate 25 (or rotating flux assembly components 15C, 15G, 25) to be set as desired. The timing relationship is defined in the number of degrees of rotation of the flux return assembly with respect to a magnet pair. A convenient, but meaningful, zero point for the flux return assembly is the center of a part of plate 25 between two holes 26 being directly in line with magnet 20A. A convenient, but meaningful, starting point of a piston (such as magnet 40A) is the magnet being at the lowest possible point in its stroke. We refer to this position of the piston as being top dead center (TDC), similar to the nomenclature used with internal combustion engines. This timing is of some importance for the most efficient function of the engine and, in a preferred embodiment, is zero (0) degrees.

There is a slight variation that results in a further decrease in the required input force. In this alternative embodiment the timing is retarded by seven (7) degrees.

In one embodiment, the static start initiator force (torque) is over 2200 ounce-inches, while the running initiator force requirement is in the 1100 ounce-inch range. In this embodiment there is a net gain of between 890 to 3220 ounce-inches depending upon the speed of rotation of the engine. Two factors which seem to be involved in this net gain are the speed of rotation and the Lenz acceleration point.

Lenz's law states “An induced current is always in such a direction as to oppose the motion or change causing it.” Thus, it is hypothesized that repelling field dynamic will develop and thereby result in the acceleration of a conductor along its path of travel in the following situation.

Consider, for example, a conductor having a total thickness of ¼ inch (approximately 6.3 mm) made up of four laminated layers, the layers being parallel to the direction of motion. The layers are 1/16 inch (approximately 1.6 mm) in thickness and are electrically insulated from one another. The first is mild steel, the second and third layers are non-magnetic stainless steel, and the fourth layer is mild steel. The conductor width is 3 inches (approximately 76.2 mm) and a length of 12 inches (approximately 30.5 cm). The conductor is moving along the X axis (from left to right) at 2 feet per second (approximately 61 cm per second) from left to right.

A cylindrical N52 magnet, having a diameter of 2-inches (approximately 51 mm) and a thickness of 2 inches, has a magnetic field aligned with the axis of the cylinder. The cylinder is set in motion at 10 feet per second (approximately 305 cm per second) downward towards the conductor. The initial location of the magnet prior to motion is such that the axial center of the magnet is directly above the right edge of the conductor and one inch above. The magnet is only allowed to achieve the proximity of 0.006 of an inch (approximately 0.15 mm) to the surface of the conductor. The magnet is set in motion along the Y axis (from top to bottom), the magnetic field and axis of the cylinder being on the Y-axis.

Directly below this N52 magnetic cylinder is a second N52 magnetic cylinder of approximately the same dimensions and magnetic field characteristics. The polarity of the magnetic field of this second cylinder is such as to present a like polarity to that of the first cylinder. Thus these magnets are in repelling configuration. Each magnet possesses a field strength of 5460 Gauss. The first magnet is fixed on the X axis but movable on the Y axis, but the second magnet is fixed on both the X and Y Axes. The second magnet is fixed at a distance of 0.125 inch (approximately 3.2 mm) from the bottom surface of the conductor.

As the magnet closes in proximity with the conductor the magnet will tend to accelerate toward the conductor due to the iron content of the top layer of the conductor. Also, due to the movement of the conductor in the magnetic field created by the magnets on opposite sides of the conductor, electromagnetic fields will develop within the conductor that are of like polarity to those magnets. The field strengths increases as the trailing edge of the conductor crosses the axial center of the magnetic field. The X axis Lenz field is less than 10% of the Y axis Lenz field. The majority of the energy creating the Y axis field is a result of the magnet being attracted to the top, high-iron content lamination layer with the two inner layers providing additional inductive potential. This is due to the lower velocity along the X axis and the insulated laminations along the X axis which break up the internal eddy currents along the X axis. Also, there appears to be an induced field linkage between the X axis and Y axis Lenz effects. If a magnet is fixed along the X axis then the conductor will be repelled (accelerated) along its present path of travel.

If this arrangement is duplicated in a circular configuration and there is another magnet 180 degrees off of the first then the conductor will accelerate at ever increasing velocity until one of several barriers is reached. One would be the magnetic moment of the materials making up the conductor. If the magnetic moment is long then the resulting induced field will not have time to decay to a chaotic state within the material prior to being acted upon by the next magnet pair. Thus, a situation of unlike fields would be present on the opposite side of the engine. This results in greater attraction towards the second magnet pair provided that the second magnetic pair is configured with an inverse repelling configuration to the first pair. Another barrier would be the X axis Lenz effect barrier. As the X axis velocity increases the Lenz effect also increases along that axis. There is a point at which the Y axis induction will reach a point of saturation or other instability, thus preventing any further acceleration.

Although the use of permanent magnets 20 and 40 has been disclosed, it will be appreciated that electromagnets may be used if desired to obtain additional field strength, especially, but not limited to, magnets 20A, 20B which are fixed.

It will be appreciated that the engine described herein provides for torque conversion by controlling magnetic fields, such as by selectively interrupting the magnetic fields. Also described herein is a device for direct control of magnetic fields.

Although various embodiments of the present invention have been described in detail herein, other variations may occur to those reading this disclosure without departing from the spirit of the present invention. Accordingly, the scope of the present invention is to be limited only by the claims.

I claim:

1. A reciprocating magnet engine, comprising:
a first magnet pair comprising a primary magnet and a corresponding opposing magnet aligned upon a common axis, said primary magnet and said opposing magnet each having a magnetic field and being oriented so that their magnetic fields are in opposition;
a second magnet pair comprising a primary magnet and a corresponding opposing magnet aligned upon a common axis, said primary magnet and said opposing magnet each having a magnetic field and being oriented so that their magnetic fields are in opposition;
a first section having first and second voids therein, said primary magnets of said first and second magnet pairs being secured in said first and second voids, respectively, said first section comprising a continuous flux return plate and a core to conduct said magnetic fields of said primary magnets;
a second section having third and fourth voids therein, said opposing magnets of said first and second magnet pairs being movable in a linear motion within said third and fourth voids, respectively, said second section to conduct said magnetic fields of said opposing magnets;
an interrupting flux return plate interposed between said first section and said second section, said interrupting flux return plate being composed of a high relative magnetic permeability material and having a low relative magnetic permeability section therein, said interrupting flux return plate having a closed position with respect to a said magnet pair wherein said high relative magnetic permeability section is between said primary and opposing magnets of a said magnet pair and substantially reduces magnetic interaction between said primary and opposing magnets in said magnet pair, said opposing magnet being attracted to said high relative magnetic permeability section which is between said primary and opposing magnets of said magnet pair, said interrupting flux return plate also having an open position with respect to said magnet pair wherein said low relative magnetic permeability section is between said primary and opposing magnets of said magnet pair, said low relative magnetic permeability section sized to allow substantial magnetic interaction between said primary and opposing magnets in said magnet pair when said interrupting flux return plate is in said open position with respect to said magnet pair;
said first section and said interrupting flux return plate to complete a magnetic flux path for a said primary magnet of a said magnet pair when said interrupting flux return plate is in said closed position with respect to said magnet pair;
said second section and said interrupting flux return plate to complete a magnetic flux path for a said opposing magnet of a said magnet pair when said interrupting flux return plate is in said closed position with respect to said magnet pair;
a control shaft connected to said interrupting flux return plate, said core, and said continuous flux return plate to rotate said interrupting flux return plate, said core, and said continuous flux return plate;
an output drive shaft; and
first and second drive assemblies to connect said opposing magnets to said output drive shaft in a complementary manner to allow said opposing magnets to move in a reciprocating relationship with respect to said output drive shaft and to rotate said output drive shaft.

2. The reciprocating magnet engine of claim 1 wherein said magnetic field of said primary magnet of said first magnet pair has a north pole oriented in a first direction, and said magnetic field of said primary magnet of said second magnet pair has a north pole oriented opposite to said first direction.

3. The reciprocating magnet engine of claim 1 wherein said interrupting flux return plate has a central axis and has a plurality of low relative magnetic permeability sections evenly spaced radially around said central axis.

4. The reciprocating magnet engine of claim 1 wherein said interrupting flux return plate has a central axis and has an odd number of low relative magnetic permeability sections evenly spaced radially around said central axis.

5. The reciprocating magnet engine of claim 1 wherein the low relative magnetic permeability section of said interrupting flux return plate is a hole.

6. The reciprocating magnet engine of claim 1 wherein said interrupting flux return plate has a central axis comprises a plurality of said low relative magnetic permeability section, said section being a slotted arch having an angular width of 40 degrees, said sections being evenly spaced radially around said central axis.

7. The reciprocating magnet engine of claim 1 wherein said first section further comprises a body and a cover plate, said body having said first and second voids therein and having a cavity for containing said core, said primary magnets secured within said first and second voids, said cover plate having a cavity to partially enclose said continuous flux return plate.

8. The reciprocating magnet engine of claim 1 wherein at least one of said interrupting flux return plate, said core, or said continuous flux return plate is laminated.

9. The reciprocating magnet engine of claim 1 and further comprising a spacer interposed between said first section and said second section to separate said first and second sections and to partially enclose and provide space for said interrupting flux return plate between said first and second sections.

10. The reciprocating magnet engine of claim 1 wherein said output drive shaft is a crankshaft, and wherein a said drive assembly comprises a piston cup, a wrist pin, and a connecting rod, said piston cup to contain a said opposing magnet, said opposing magnet being secured within said piston cup, said wrist pin to secure said piston cup to said connecting rod to convert linear motion of said piston cup into rotating motion of said output drive shaft.

11. The reciprocating magnet engine of claim 1 wherein interrupting flux return plate comprises: 1/16 inch of high iron content mild steel, an insulator, 1/16 inch low iron content tool steel, an insulator, 1/16 inch low iron content tool steel, an insulator; and 1/16 inch of high iron content mild steel.

12. The reciprocating magnet engine of claim 1 wherein the core comprises: ½ inch of high iron content mild steel, ½ inch of high iron content mild steel, 1/16 inch of high iron content mild steel, ½ inch of high iron content mild steel and ½ inch of high iron content mild steel.

13. The reciprocating magnet engine of claim 1 where the continuous flux return plate 15G comprises: 1/16 inch of low iron content tool steel, an insulator, 1/16 inch of low iron content tool steel, an insulator, 1/16 inch of low iron content tool steel, an insulator, and 1/16 inch of low iron content tool steel.

14. A magnetic field controller, comprising:
a continuous flux return plate composed of a high relative magnetic permeability material;
a core composed of a high relative magnetic permeability material and connected to said continuous flux return plate;
an interrupting flux return plate connected to said core and composed of a high relative magnetic permeability material and having a low relative magnetic permeability section therein;
a control shaft to rotate said continuous flux return plate, said core, and said interrupting flux return plate, said control shaft being connected to at least one of said continuous flux return plate, said core, or said interrupting flux return plate.

15. The magnetic field controller of claim 14 and further comprising an enclosure to enclose said continuous flux return plate and said core and the side of said interrupting flux return plate connected to said core.

16. The magnetic field controller of claim 14 wherein the low relative magnetic permeability section of said interrupting flux return plate is a hole.

17. The magnetic field controller of claim 14 wherein at least one of said interrupting flux return plate, said core, or said continuous flux return plate is laminated.

18. The magnetic field controller of claim 14 wherein the interrupting flux return plate comprises: 1/16 inch of high iron content mild steel, an insulator, 1/16 inch low iron content tool steel, an insulator, 1/16 inch low iron content tool steel, an insulator; and 1/16 inch of high iron content mild steel.

19. The magnetic field controller of claim 14 wherein the core comprises: ½ inch of high iron content mild steel, ½ inch of high iron content mild steel, 1/16 inch of high iron content mild steel, ½ inch of high iron content mild steel and ½ inch of high iron content mild steel.

20. The magnetic field controller of claim 14 where the continuous flux return plate 15G comprises: 1/16 inch of low iron content tool steel, an insulator, 1/16 inch of low iron content tool steel, an insulator, 1/16 inch of low iron content tool steel, an insulator, and 1/16 inch of low iron content tool steel.
